(19) United States
(12) Patent Application Publication
(10) Pub. No.: US 2004/0171323 A1
(43) Pub. Date: Sep. 2, 2004

(54) Antimicrobial, synthetic, fibrous, and tubular medical divices

(76) Inventor: Shalaby W. Shalaby, Anderson, SC (US)

Correspondence Address: LEIGH P. GREGORY, ATTORNEY AT LAW, PO BOX 168, CLEMSON, SC, 29633-0168, US

(21) Appl. No.: 10/758,356

(22) Filed: Jan. 15, 2004

Related U.S. Application Data
(63) Continuation-in-part of application No. 10/453,804, filed on Jun. 3, 2003.
Application No. 10/453,804 is a division of application No. 09/506,046, filed on Feb. 17, 2000, now Pat. No. 6,596,657.
(60) Provisional application No. 60/120,392, filed on Feb. 17, 1999.

(51) Int. Cl. B32B 5/02; B32B 27/04; B32B 27/12; D03D 15/00; D04B 1/00; B32B 5/26; D03D 25/00; D04B 7/00; D04B 9/00; D04B 11/00; D04B 21/00

(52) U.S. Cl. 442/123; 442/181; 442/268; 442/304; 442/319

(57) ABSTRACT

The present invention is directed toward antimicrobial absorbable and non-absorbable fibrous and tubular medical devices comprising synthetic polymers and one or more antimicrobial agent molecularly dispersed within the surface to allow the continuous release of said agent or agents under simulated physiologic conditions for at least one week.

This is a continuation-in-part application to U.S. Ser. No. 10/453,804, filed on Jun. 3, 200, which is a divisional of U.S. Ser. No. 09/506,046 filed on Feb. 17, which claimed the benefit of prior provisional application U.S. Ser. No. 60/120,392, filed Feb. 17, 1999, and which issued as U.S. Pat. No. 6,596,657 on Jul. 22, 2003.

### FIELD OF THE INVENTION

This invention relates to antimicrobial, absorbable and non-absorbable synthetic, polymeric, fibrous, and tubular medical devices comprising one or more active agent that is molecularly dispersed preferentially within the surface while creating a concentration gradient featuring a maximum concentration near the solid-air interface that decreases with distances inwardly.

### BACKGROUND OF THE INVENTION

Polymeric medical devices made, at least in part, by melt-extrusion/spinning, melt-blowing, spin-bonding, and electrostatic spinning (or electrospinning) include absorbable and non-absorbable monofilament and braided sutures, knitted or braided tapes, knitted or woven meshes, vascular grafts, vascular patches, ligating devices, pledgets, hemostatic pads, and indwelling catheters. All of these devices are used in one or more medical application, including wound repair.

Polymeric medical devices prepared from extruded filaments and/or yam include mesh prostheses, conventionally, are used to repair hernias. Such mesh fabric prostheses are also used in other surgical procedures including the repair of anatomical defects of the abdominal wall, diaphragm, and chest wall, correction of defects in the genitourinary system, and repair of traumatically damaged organs such as the spleen, liver or kidney. Mesh fabrics for use in connection with hernia repairs are disclosed in U.S. Pat. Nos. 5,292,328, 4,769,038, and 2,671,444. Knitted and woven fabrics constructed from a variety of synthetic fibers and the use of the fabrics in surgical repair are also discussed in U.S. Pat. Nos. 3,054,406; 3,124,138; 4,193,137; 4,347,847; 4,452,245; 4,520,821; 4,633,873; 4,652,264; 4,655,221; 4,838,884; and 5,002,551.

Polymeric surgical devices prepared from extruded filaments and/or yarn also include mono- and multifilament sutures. Such sutures are disclosed in, for example, U.S. Pat. Nos. 4,557,264 and 4,911,165.

It is important during the healing process and subsequent thereto that the surgical devices placed within the body do not provide for the growth of bacteria on or immediately about the surgical device. Medical devices that utilize antimicrobial agents applied to their surfaces are known. For example, U.S. Pat. Nos. 3,642,003 and 3,862,304 disclose sutures coated with germicidal ions. U.S. Pat. No. 5,019,096 discloses devices, e.g., sutures, comprising coatings of antimicrobial agents. U.S. Pat. No. 5,534,288 discloses substrates made from filaments, which substrates are then impregnated with an antimicrobial agent. The impregnating agent is said to flow into the interstices between the filaments from which the substrate is formed. U.S. Pat. No. 5,534,288 describes the impregnation process to consist of forcing the drug-load impregnating agent into pre-existing or created interstices or cracks. U.S. Pat. No. 6,514,517 discloses an antimicrobial suture having a coating comprising an acid-producing antimicrobial compound. U.S. Pat. Nos. 6,197,320 and 6,485,749 teach a nitrogenous polyester coating for medical devices, which can contain an antimicrobial agent. European patent 1,157,708 A2 deals with surgical devices containing an antimicrobial agent homogeneously dispersed throughout.

U.S. Pat. No. 6,596,657 discloses a totally different approach from those described above to produce antimicrobial fabric by incubating the fabric in a solution of an agent at such temperatures to allow its diffusion molecularly into the individual fiber surface and remain molecularly dispersed within said fiber until the fabric is put to use. During such use, the dispersed drug will diffuse molecularly from intermolecular space of the substrate to the surrounding medium at a predetermined rate that depends on initial agent concentrations and physicochemical properties of the substrate. It would be advantageous to extend this concept of introducing antimicrobial agents to critical surgical polymeric articles such as sutures, ligatures, meshes, and fiber-based vascular constructs without relying on methods of the prior art which are based on (1) incorporating the agent in a surface coating with unpredictable residence time and performance at the surgical site due to its susceptibility to delamination due to frictional forces encountered during application; and (2) incorporating the agent during melt-processing to attain a uniform distribution (not on the molecular level) in the matrix of articles which can compromise the melt-process used to convert the polymer into useful articles. This is, in part, because of the possibility of undesirable polymer-agent interactions that compromise the sought properties of either or both. Accordingly, the present invention deals with an antimicrobial fibrous surgical device made of absorbable and non-absorbable polymer wherein the antimicrobial agent is dispersed molecularly within the surface of said article while creating a concentration gradient featuring a maximum concentration near the solid-air interface that decreases steadily with distance inwardly.

Similar to the fibrous medical devices noted above are non-absorbable polymeric indwelling catheters. Those are often indwelled in the central vein for purposes including administration of intravenous fluid, parenteral nutrition, and chemotherapy. Of particular importance are those used in conjunction with hemodialysis. Indwelling catheters are essential for the treatment of paraplegic, geriatric, and spinal cord-injured patients. Meanwhile, indwelling catheters are considered to be one of the most frequent sites for nosocomial infection. Urethral catheters, widely used for the drainage of the bladder, are associated with most urinary tract infections. Accordingly, there is also an obvious need to develop antimicrobial catheters exhibiting release profile characteristics of active agents molecularly dispersed within the surface of the catheter while creating a concentration gradient featuring maximum concentration near the solid-air interface that decreases steadily with distance inwardly. In both the fibrous and tubular medical devices, it would be preferable that such concentration gradient and the drug-polymer interaction allow the drug release according to zero-order kinetics during the critical period of their functional performance.

### SUMMARY OF THE INVENTION

Accordingly, the present invention is directed to an antimicrobial, synthetic, polymeric, medical device which has a device surface defining a surface-air interface and having at least one active agent molecularly dispersed, preferentially within the surface, and having a concentration gradient wherein a maximum concentration of the at least one active agent is present at or adjacent to the surface-air interface and wherein the concentration of the at least one active agent within the device decreases with the distance from the surface-air interface, such that in the biologic environment the at least one active agent is released in accordance with a controlled release profile, initially displaying essentially first-order kinetics and subsequently displaying essentially zero-order kinetics. In a preferred embodiment the present device is a continuous-wall, flexible catheter formed of a polymer such as segmented polyether ester, segmented polyether amide, segmented polyether urethane, polyethylene or a polysiloxane copolymer.

In another embodiment the present device is a non-absorbable monofilament suture formed from a polymer such as Nylon 6, segmented polyether ester, segmented polyether amide, or polypropylene. In yet another embodiment the present device is a non-absorbable braided suture formed from a polymer such as Nylon 66, Nylon 610, or polyethylene terephthalate.

In a still further embodiment the present device is a non-absorbable woven or knitted mesh formed from at least one polymer such as polypropylene, polyethylene terephthalate, or polytetramethylene terephthalate. Alternatively, the present device is a non-absorbable woven or knitted vascular construct formed from at least one polymer such as polypropylene, polyethylene terephthalate, or polytetramethylene terephthalate.

In another embodiment the present device is an absorbable monofilament or multifilament braided suture made from a polymer having repeat units derived from at least one monomer such as glycolide, 1-lactide, d1-lactide, p-dioxanone, ε-caprolactone, trimethylene carbonate, 1,5-dioxepan-2-one, or 1,4-morpholine-2-one.

In yet another embodiment the present device is a partially absorbable composite woven or knitted mesh wherein the non-absorbable component is formed from a non-absorbable polymer such as polypropylene or polyethylene terephthalate and wherein the absorbable component is formed from an absorbable polymer having repeat units derived from at least one monomer such as glycolide, 1-lactide, d1-lactide, p-dioxanone, ε-caprolactone, trimethylene carbonate, 1,5-dioxepan-2-one, or 1,4-morpholine-2-one. Preferably the absorbable component is a non-woven fabric formed from electrostatically spun nano-/microfibers.

In an alternative embodiment the present device is a composite vascular construct having a blood-contacting, surface modified, non-absorbable component which is woven or knitted polypropylene or polyethylene terephthalate yarn and a tissue contacting absorbable component which is a non-woven fabric of electrostatically nano-/microfibers made of a segmented copolyester or polyether-ester having repeat units derived from at least one cyclic monomer such as glycolide, 1-lactide, d1-lactide, p-dioxanone, ε-caprolactone, trimethylene carbonate, 1,5-dioxepan-2-one, or 1,4-morpholine-2-one.

Preferably, the present device includes 0.005 to 0.5 percent of an antimicrobial agent such as triclosan sodium, benzolkonium chloride, a chlorhexidine salt, norfloxacin, or triclocarban.

Preferred devices in accordance with the present invention include knitted, woven, or composite, partially absorbable meshes, surgical monofilament or braided sutures, and twisted multifilament yarn. A preferred device in accordance with the present invention is a non-absorbable monofilament or braided suture which includes at least one bioactive agent selected from the group consisting of triclosan sodium, triclocarban and norfloxacin.

It is preferred that any device in accordance with the present invention is capable of the sustained release of the at least one active agent for at least one week.

More specifically, the present invention is directed to antimicrobial, absorbable and non-absorbable polymeric, fibrous and tubular medical devices comprising one or more active agent that is molecularly dispersed, preferentially within the surface of said device, while creating a concentration gradient featuring a maximum concentration near the solid-air interface that decreases with distance inwardly. An aspect of this invention deals with an antimicrobial polymeric medical device capable of displaying a controlled release profile of its active agent or agents in the biologic environment or simulated physiologic conditions, wherein said profile displays first-order kinetics, initially, followed by zero-order kinetics. A specific aspect of this invention deals with a antimicrobial, synthetic, polymeric device in the form of continuous-wall, flexible catheters made of one of the polymers selected from the group represented by segmented polyether ester, segmented polyether amide, segmented polyether urethane, polyethylene and a polysiloxane copolymer. Another specific aspect of this invention is directed to a antimicrobial, synthetic medical device in the form of a non-absorbable monofilament suture made of one of the polymers selected from the group represented by Nylon 6, segmented polyether ester, segmented polyether amide, and polypropylene.

A specific aspect of this invention relates to antimicrobial, fibrous medical devices in the form of non-absorbable braided sutures made from one of the polymers selected from the group represented by Nylon 66, Nylon 610, and polyethylene terephthalate. Another specific aspect of this invention deals with antimicrobial, synthetic, polymeric medical devices in the form of non-absorbable woven or knitted meshes made of one or more of the polymers selected from the group represented by polypropylene, polyethylene terephthalate, and polytetramethylene terephthalate. Another specific aspect of this invention covers synthetic, polymeric, fibrous medical devices in the form of non-absorbable woven or knitted vascular constructs, including vascular grafts and patches, made of one or more of the polymers selected from the group represented by polypropylene, polyethylene terephthalate, and polytetramethylene terephthalate. Another specific aspect of this invention deals with antimicrobial, synthetic, polymeric medical devices in the form of absorbable monofilament and braided sutures as well as multifilament twisted yarn made from a polymer based on one or more of the monomers selected from the group represented by glycolide, 1-lactide, d1-lactide, p-dioxanone, ε-caprolactone, trimethylene carbonate, 1,5-dioxepan-2-one, 1,4-morpholine-2-one. Another aspect of the invention relates to antimicrobial, synthetic, polymeric medical devices in the form of partially absorbable composite woven or knitted meshes wherein the non-absorbable component is made of a polymer selected from the group represented by polypropylene and polyethylene terephthalate and the absorbable component is made of an absorbable polymer based on one or more of the monomers selected from the group represented by glycolide, 1-lactide, d1-lactide, p-dioxanone, ε-caprolactone, trimethylene carbonate, 1,5-dioxepan-2-one, 1,4-morpholine-2-one. Another aspect of the invention relates to antimicrobial, synthetic polymeric, fibrous medical devices in the form of partially absorbable mesh wherein the absorbable component is made of non-woven fabric comprising electrostatically spun nano-/microfibers. A specific aspect of the present invention deals with antimicrobial, synthetic, polymeric, fibrous medical devices in the form of composite vascular constructs comprising a blood-contacting, surface modified, non-absorbable component made of woven or knitted polypropylene or polyethylene terephthalate yarn and tissue contacting absorbable component made of non-woven fabric based on electrostatically nano-/microfibers made of a segmented copolyester or polyether-ester comprising repeat units derived from one or more cyclic monomer selected from the group represented by glycolide, 1-lactide, d1-lactide, p-dioxanone, ε-caprolactone, trimethylene carbonate, 1,5-dioxepan-2-one, 1,4-morpholine-2-one. Another aspect of the present invention addresses antimicrobial, synthetic, polymeric, fibrous medical devices comprising 0.002 to 1.0 percent and preferably 0.005 to 0.5 percent and more preferably 0.01 to 0.3 percent of an antimicrobial agent selected from the group represented by trichlosan sodium, benzolkonium chloride, a chlorhexidine salt, norfloxacin, and triclocarban. A specific aspect of this invention deals with antimicrobial, synthetic, polymeric, fibrous medical devices in the form of a monofilament surgical suture, twisted multifilament yarn, braided multifilament sutures, composite woven and knitted, non-absorbable or partially absorbable mesh, and composite absorbable or partially absorbable mesh with the latter being made of electrostatically spun nano-/microfiber wherein the said medical devices exhibit a controlled release profile of its active agent or agents in the biologic environment or under simulated physiologic conditions wherein said profile displays first-order kinetics, initially, followed by zero-order kinetics. Another specific aspect of this invention deals with antimicrobial, synthetic, polymeric, fibrous medical devices in the form of absorbable or non-absorbable monofilament or braided sutures comprising one or more bioactive agent selected from the group represented by triclosan sodium, triclocarban and norfloxacin. A general aspect of this invention deals with antimicrobial, synthetic, polymeric, medical devices made of absorbable or non-absorbable polymers that are present in the form of fibrous articles such as monofilament and multifilament sutures and meshes or can also be present in tubular form as in catheters wherein said devices are capable of releasing discernable amounts of a thin, bioactive agent or agents including those having antimicrobial activity for at least one week in the biologic environment or under simulated physiologic conditions.

### DETAILED DESCRIPTION OF PREFERRED EMBODIMENTS

The present invention is generally directed to antimicrobial, fibrous, and tubular medical devices comprising an absorbable or non-absorbable synthetic polymer and one or more antimicrobial agent molecularly dispersed within the surface of the device. The molecular dispersion of the bioactive agent requires that (1) the activity of the agent in the heated liquid carrier approaches unity; (2) the compatibility of the liquid with the polymer matrix is such that the agent solution diffuses freely into the polymer matrix at the application temperature; and (3) the interaction of the agent with the polymer matrix upon drying does allow the agent crystallization into any solid form that exhibits a melting endotherm in a typical DSC thermogram.

A specific aspect of the invention deals with fibrous devices in the form of monofilament and braided surgical sutures, woven and non-woven meshes, woven and knitted vascular grafts, and microfibrous, non-woven constructs made by electrostatic spinning. In another aspect of the invention, the molecularly dispersed antimicrobial agent (or agents) is present at a maximum concentration near the fiber-air interface as per a concentration gradient that decreases steadily toward the central longitudinal axis of said fiber or the midline within the wall that is encompassed in the middle circumference between the outer and inner surface of a tubular device. The concentration gradient associated with the drug in the polymer matrix is determined using a drug loaded film as a model, wherein the profiling of the drug concentration is achieved by slicing or microtoming thin layers (or lamellae) at a parallel plane to the surface of the film. This is followed by analyzing for the drug of the individual slices (or lamellae) obtained at different distances from the surface. A preferred aspect of the present invention deals with antimicrobial sutures exhibiting a controlled release profile of the active agent (or agents) in the biologic environment or under simulated physiological conditions that displays first-order kinetics, initially, followed by zero-order kinetics. Another preferred aspect of the present invention deals with antimicrobial, fibrous, medical device wherein 10 to 50 percent of their molecularly dispersed agent (or agents) is present within 10-20 percent of the distance from the fiber-air interface and less than 5 percent is present at the innermost distance extending to the central axis of the individual fiber or the midline within the wall of a tubular device. A specific aspect of the invention deals with antimicrobial tubular devices in the form of indwelling catheters, such as those generally used in the treatment of paraplegic, geriatric, and spinal cord-injured patients. A more specific aspect of the invention deals with antimicrobial tubular devices in the form of flexible catheters, such as those used in conjunction with hemodialysis. Another specific aspect of the invention deals with antimicrobial tubular devices in the form of flexible catheters indwelled in the central vein for purposes including administration of intravenous fluid, parenteral nutrition, and chemotherapy. Another specific aspect of this invention deals with antimicrobial tubular devices in the form of stents for maintaining patency of biological conduits, such as blood vessels and ureters.

The invention may be further understood by reference to the following examples, which are provided for the purpose of representation and are not to be construed as limiting the scope of the invention.

### EXAMPLE 1

General Method for Drug Concentration Profiling

Polymer granules are compression molded at a temperature that exceeds their Tₘ by 1 to 10° C. into 10×10×1 cm sheets. These are cut into 8×6×1 cm pieces. Individual pieces than are uniaxially oriented in the solid-state in a U-shaped mold (6 cm wide and 16 cm long) below the polymer Tₘ by applying a compressive force perpendicular to the surface to reduce the thickness to 0.8 cm as described in U.S. Pat. No. 5,529,736 (1996). The oriented pieces are incubated in the specific drug solution under conditions similar to those used in loading the drug into the fibers or catheters; this is to achieve molecular dispersion within the surface. The treated pieces are removed, scoured, and dried as noted for their fibrous counterparts and then cut to the precise dimensions to fit the sample holder of a microtome. Depending on the physical properties of the polymer, 5 to 15 micron lamellae (microfilms) are prepared by cutting through in a plane parallel to the sample surface. Each microfilm is divided into (1) a sample to pursue ESCA analysis for elements such as Cl, N, or S on the top side of the microfilm; and (2) a sample to determine drug concentration, after exhaustive extraction with the proper solvent, using HPLC. Several lamellae (or microfilms) are prepared to allow sampling within the 5-10% and 40-50% distance from the original surface.

### EXAMPLE 2

General Method for Detecting any Drug Crystal in Treated Drug-loaded Fibers in Microfilms and Similar Thin Specimens

This method is designed to determine the presence of possible first-order transition due to melting of any particular drug that may be present in the polymer matrix as crystalline particles. For this, microfilms (or lamellae) from Example 1, small diameter fibers and surface micro-sections of catheters containing the maximum possible concentration of drug are subjected to thermal analysis using differential scanning calorimetry (DSC). The absence of a melting endotherm in the DSC thermogram will be indicative of having the drug in a molecular dispersed form that is not capable of aggregation and crystallization during the thermal analysis experiment. For drugs having a melting point that is higher than the Tₘ of the polymeric matrix, the specimen is heated above the drug melting point using a heating rate of 40° C./min; this is only applicable to drugs that do not dissolve immediately as the polymer melts. On the other hand, if the drug melts below the Tₘ of the polymer matrix, the sample is heated above the polymer melting point using a heating rate of 20° C./min.

### EXAMPLE 3

Incorporation of Trichlosan Sodium into Sutures—General Method

A solution containing a known concentration of triclosan sodium (e.g., 4.7% wt/wt) in aqueous 2-propanol (60/40 wt/wt H₂O/IPA) was prepared as described in U.S. Pat. No. 6,596,657 (2003). The suture was scoured with acetone and then 2-propanol (IPA) at room temperature. After air drying in a laminar flow hood, the suture was incubated in a preheated triclosan solution at the desired temperature (preferably 50° C.) for a predetermined period of time (preferably 30 min). The treated sutures were removed and dried in a laminar flow hood at room temperature, then rinsed twice with 60/40% wt/wt H₂O/IPA and then once with 99% propanol at room temperature for at least 5 minutes at each rinse. The suture was redried at room temperature at atmospheric pressure and then under reduced pressure until a constant weight is realized.

### EXAMPLE 4

Determination of the Total Triclosan Concentration in Treated Polypropylene Sutures—General Method

The drug was removed by exhaustive extraction of the dried suture in 50/50% vol/vol acetonitrile/H₂O at 50° C. for at least 2 hours or until no drug could be detected in the extract. The extent of the extraction was monitored using HPLC. The drug contents in the combined extracts were then determined using HPLC.

### EXAMPLE 5

Determination of the Release Profile of Triclosan from Treated Sutures—General Method

The dried suture was cut in more than 30 cm length pieces that were placed in a sample compartment that is part of a continuous flow system wherein a fresh phosphate buffer at pH 7.4 and 37° C. continually contacts the suture and the eluants are collected in a cold receptacle and analyzed at 1- to 3-day intervals. The content of the drug in eluant is determined using HPLC. The HPLC data are used to construct the release profile of the drug over the desired period of time or until the concentration of the drug in the eluant becomes too low to be analyzed by HPLC.

### EXAMPLE 6

Incorporation of Triclocarban into Sutures—General Method

This is conducted following a procedure similar to that used in Example 3 with the exception of (1) using a solution of drug in ethanol (e.g., 1.5% wt/wt) ; and (2) rinsing twice with ethanol.

### EXAMPLE 7

Determination of Total Triclocarban Concentration in Sutures—General Method

This is conducted following a procedure similar to that used in example 4 with the exception of using 80/20% vol/vol acetonitrile/water.

### EXAMPLE 8

Determination of the Release Profile of Triclocarban from Treated Sutures—General Method

This was conducted following a protocol similar to that described in Example 5.

Preferred embodiments of the invention have been described using specific terms and devices. The words and terms used are for illustrative purposes only. The words and terms are words and terms of description, rather than of limitation. It is to be understood that changes and variations may be made by those of ordinary skill art without departing from the spirit or scope of the invention, which is set forth in the following claims. In addition it should be understood that aspects of the various embodiments may be interchanged in whole or in part. Therefore, the spirit and scope of the appended claims should not be limited to descriptions and examples herein.

What is claimed is:

1. An antimicrobial, synthetic, polymeric, medical device comprising a device surface defining a surface-air interface and having at least one active agent molecularly dispersed, preferentially within the surface, and having a concentration gradient wherein a maximum concentration of the at least one active agent is present at or adjacent to the surface-air interface and wherein the concentration of the at least one active agent within the device decreases with the distance from the surface-air interface, such that in the biologic environment the at least one active agent is released in accordance with a controlled release profile, initially displaying essentially first-order kinetics and subsequently displaying essentially zero-order kinetics.

2. An antimicrobial, synthetic, polymeric medical device as set forth in claim 1 in the form of continuous-wall, flexible catheters formed of a polymer selected from the group consisting of segmented polyether ester, segmented polyether amide, segmented polyether urethane, polyethylene and a polysiloxane copolymer.

3. An antimicrobial synthetic, polymeric medical device as set forth in claim 1 in the form of a non-absorbable monofilament suture formed from a polymer selected from the group consisting of Nylon 6, segmented polyether ester, segmented polyether amide, and polypropylene.

4. An antimicrobial synthetic, polymeric, medical device as set forth in claim 1 in the form of non-absorbable braided sutures formed from a polymer selected from the group consisting of Nylon 66, Nylon 610, and polyethylene terephthalate.

5. An antimicrobial synthetic, polymeric, medical device as set forth in claim 1 in the form of a non-absorbable woven or knitted mesh formed from at least one polymer selected from the group consisting of polypropylene, polyethylene terephthalate, and polytetramethylene terephthalate.

6. An antimicrobial synthetic, polymeric, medical device as set forth in claim 1 in the form of a non-absorbable woven or knitted vascular construct formed from at least one polymer selected from the group consisting of polypropylene, polyethylene terephthalate, and polytetramethylene terephthalate.

7. An antimicrobial synthetic, polymeric, medical device as set forth in claim 1 in the form of absorbable monofilament and multifilament braided sutures made from a polymer comprising repeat units derived from at least one monomer selected from the group consisting of glycolide, 1-lactide, d1-lactide, p-dioxanone, ε-caprolactone, trimethylene carbonate, 1,5-dioxepan-2-one, and 1,4-morpholine-2-one.

8. An antimicrobial synthetic, polymeric, medical device as set forth in claim 1 in the form of a partially absorbable composite woven or knitted mesh wherein the non-absorbable component is formed from a non-absorbable polymer selected from the group consisting of polypropylene and polyethylene terephthalate and the absorbable component is formed from an absorbable polymer comprising repeat units derived from at least one monomer selected from the group consisting of glycolide, 1-lactide, d1-lactide, p-dioxanone, ε-caprolactone, trimethylene carbonate, 1,5-dioxepan-2-one, and 1,4-morpholine-2-one.

9. An antimicrobial synthetic, polymeric, medical device as set forth in claim 8 wherein the absorbable component comprises non-woven fabric comprising electrostatically spun nano-/microfibers.

10. An antimicrobial synthetic, polymeric, medical device as set forth in claim 1 in the form of a composite vascular construct comprising a blood-contacting, surface modified, non-absorbable component comprising woven or knitted polypropylene or polyethylene terephthalate yarn and a tissue contacting absorbable component comprising non-woven fabric comprising electrostatically nano-/microfibers made of a segmented copolyester or polyether-ester comprising repeat units derived from at least one cyclic monomer selected from the group consisting of glycolide, 1-lactide, d1-lactide, p-dioxanone, ε-caprolactone, trimethylene carbonate, 1,5-dioxepan-2-one, and 1,4-morpholine-2-one.

11. An antimicrobial synthetic, polymeric, medical device as set forth in claim 1 comprising 0.005 to 0.5 percent of an antimicrobial agent selected from the group consisting of triclosan sodium, benzolkonium chloride, a chlorhexidine salt, norfloxacin, and triclocarban.

12. An antimicrobial, synthetic, polymeric medical device as set forth in claim 1 in the form of knitted, woven, or composite, partially absorbable mesh.

13. An antimicrobial, synthetic, polymeric medical device as set forth in claim 1 in the form of a surgical monofilament or braided suture.

14. An antimicrobial, synthetic, polymeric medical device as set forth in claim 1 in the form of a twisted multifilament yarn.

15. An antimicrobial, synthetic, polymeric medical device as set forth in claim 1 in the form of non-absorbable monofilament or braided suture comprising at least one bioactive agent selected from the group consisting of triclosan sodium, triclocarban and norfloxacin.

16. An antimicrobial, synthetic, polymeric medical device as set forth in claim 1 capable of the sustained release of the at least one active agent for at least one week.
